(19) United States
(12) Patent Application Publication
(10) Pub. No.: US 2016/0294963 A1
(43) Pub. Date: Oct. 6, 2016

(54) LOCATION INFERENCE

(71) Applicant: VODAFONE IP LICENSING LIMITED, Newbury, Berkshire (GB)

(72) Inventors: Kevin Scarr, London (GB); Oleksiy lgnatyev, London (GB)

(21) Appl. No.: 14/977,351

(22) PCT Filed: Jun. 20, 2014
(86) PCT No.: PCT/GB2014/051903

§ 371 Date: Dec. 21, 2015

(30) Foreign Application Priority Data
Jun. 20, 2013 (GB) 1311037.4
Sep. 9, 2013 (GB) 1316022.1

(51) Int. Cl. H04L 29/08; H04W 4/02; G06N 5/04

(52) U.S. Cl. CPC H04L 67/22; G06N 5/048; H04W 4/028

(57) ABSTRACT

A method for inferring a location of a user device in a network is disclosed. The method comprises retrieving event records corresponding to a user device event; identifying, for a particular user device, a time period for which there exists no event record; retrieving other event records based on the identified time period; and inferring a location for the user device during the identified time period based on the retrieved event records.

### BACKGROUND

Every business or service operates within a spatial dimension—whether this be a physical location such as a retail outlet or a virtual location via a website. In order to effectively operate the business or service, it is essential to understand the demographics and psychographic behaviour of the customers and the users of the business or service. This process is known as “footfall analytics”.

Typically, footfall analytics are performed within the retail business sector and are concerned with measuring the number of visitors to a retail outlet and the demographics of those visitors, and ideally how these translate to sales.

Footfall analytics is not just limited to the retail environment however. For example, a hospital may wish to understand the movements of its patients, a local authority may wish to understand the impact of a planned event or an online retailer may wish to understand where their customers are when using the service.

One area where footfall analytics has a particularly important application is in the field of facility management. Modern facilities comprise a number of subsystems which are configured to control aspects of the facilities. This can include both indoor facilities (such as buildings) and outdoor facilities (such as streets).

Some subsystems are controlled based on the number or characteristics of the people that are present in a given location. This traditionally involves manually counting the number of people who enter a location and interviewing a sample to determine their characteristics, such as their reason for visiting the location. This manually gathered information can then be used to approximate the number and characteristics of people in the area in the future. Based on this approximation, the various parameters of the subsystem (such as output levels and set-points) can be set. However, a key weakness with this manual process is that it is a very time-consuming to initially gather the data. Further, because the data is not at all real-time, and in fact relies on a past sample being extrapolated for future occasions, it can be very inaccurate, causing poor performance of the subsystems.

Although accurate footfall analytics would provide the best basis for automated control of subsystems, the difficulty with gathering the data has led to attempts in the prior art to consider other approaches. Some subsystems can be automatically controlled by linking the subsystem to one or more sensors. The output of the subsystem could then be automatically adjusted based on the sensor reading. For example, an air conditioning subsystem may be configured to regulate the temperature within an area to remain within two set-points, based on periodic or continuous sensor readings. However, such an approach is only suitable where there is an easily measured output, and in any case requires monitoring infrastructure to be installed and maintained.

A particularly coarse method of automatic control involves using motion sensors or the like to determine the presence of one or more people. However, this does not provide any indication of the number or kind of people who are present, and is prone to a large number of false positives and true negatives. Such methods therefore are only appropriate in very limited situations where accuracy and precision is not so important. For example, it is very difficult (or even practically impossible) to determine whether a person is a repeat visitor. While it may be possible for such sensors to determine whether a person is an adult or a child (based on the size of the person), even this is typically very inaccurate and unreliable. Any further analysis is generally impossible.

Thus there is a need in the art for improvements in methods of analysing user footfall and of controlling associated subsystems based on user footfall, or to at least provide the public with a useful choice.

### SUMMARY OF INVENTION

In a first aspect, there is provided a method for inferring a location of a user device in a network. First, a plurality of event records is retrieved. Each event record corresponds to a user device event in a network (such as a telecommunications network), and comprises a user device identifier, time information, and location information. A time period for which there exists no event record in the plurality of event records for a user device is then identified. One or more other event records from the plurality of recorded event records are then retrieved based on the identified time period; and a location for the user device during the identified time period is inferred based on the one or more retrieved event records. In this manner, a location can be inferred for a user device even where there is no direct event record corresponding to that period. This then allows for more accurate use of the data.

Retrieving one or more other event records based on the unrecorded time period may comprise retrieving a preceding event record which comprises a device identifier corresponding to the user device and time information corresponding to a time period before the unrecorded time period; and/or retrieving a following event record which comprises a device identifier corresponding to the user device and time information corresponding to a time period after the unrecorded time period. Thus, the most recent location of the user device can be compared to other event records.

The preceding event record may comprise location data relating to a first location and the following event record may comprise location data relating to a second location. In this case, the method may further comprise retrieving a route between the first location and the second location; and inferring that the user device passed along the route during the unrecorded time period. This allows for locations along predetermined routes (notably, public transport routes) to be mapped, even where there is no coverage along portions of the routes.

In preferred embodiments, the mobile user device is associated with a user. In this case, retrieving one or more other event records based on the unrecorded time period comprises retrieving one or more other event records, each of which has a second device identifier corresponding to a second user device associated with the user. Where a user carries two devices, the most accurate source of information about the location of the first of the user's device is the second of the user's device.

Identifying, for a particular user device, a time period for which there exists no event record in the plurality of event records may comprise generating, for the user device, a matrix for the user device, the matrix comprising a plurality of time slots; recording a location at at least some of the time slots based on the event records; and determining the identified time period by retrieving one or more contiguous time slots in a row of the matrix, each of which time slots not having an assigned location. The plurality of time slots of the matrix can be arranged as a plurality of rows and columns, each row relating to a day, and each column relating to a time of day. This provides a computationally efficient manner of recording the locations of a user device.

In such cases, each of the other retrieved records may correspond to an entry in a row of the matrix. Inferring a location for the user device during the identified time period based on the one or more retrieved event records can comprise: for each time slot in the identified time period, calculating the most common location in the other retrieved records for the column of the time slot; and recording the most common location as the location in the time slot.

In preferred embodiments, the time period relates to a day of the week. This may take into consideration public holidays or school holidays (for example, a Monday which is a public holiday may not be compared to a Monday which is not a public holiday). Additionally or alternatively, it may also take into account that a day of the week in relation to the month may be distinct (for example, the last Friday in a month should only be compared to the last Friday in other months, and not to intermediate Fridays). Thus, retrieving one or more other event records can comprise retrieving one or more other event records which relate to the same day of the week. This may be particularly beneficial as a user is likely to maintain a similar schedule on the same day of the week. For example, a weekday compared to a weekday is likely to be more accurate than a weekday compared to a weekend.

In preferred embodiments, the method further comprises calculating a confidence value for the inferred location; and if the confidence value exceeds a threshold value, recording the location for the user device. Thus, where high accuracy data is required, low confidence inferences can be avoided.

In a second aspect, there is provided a method for inferring the usage of service by a user device in a network. First, a plurality of event records is retrieved. Each event record corresponds to a user device event in a network (such as a telecommunications network) and comprises a user device identifier, time information, and service information. For a particular user device, a time period for which there exists no event record in the plurality of event records is retrieved. One or more other event records from the plurality of recorded event records is then retrieved based on the identified time period. The usage of a service for the user device during the identified time period is then inferred based on the one or more retrieved event records.

In preferred embodiments, the method further includes, prior to identifying a time period: monitoring that the user device has moved from a first network to a second network.

In a third aspect, there is provided a computer-readable medium having computer-executable instructions stored thereon which, when executed by a computer, cause the computer to perform the method of the first or second aspects.

### BRIEF DESCRIPTION

The present invention will now be described with reference to the accompanying drawings, in which:

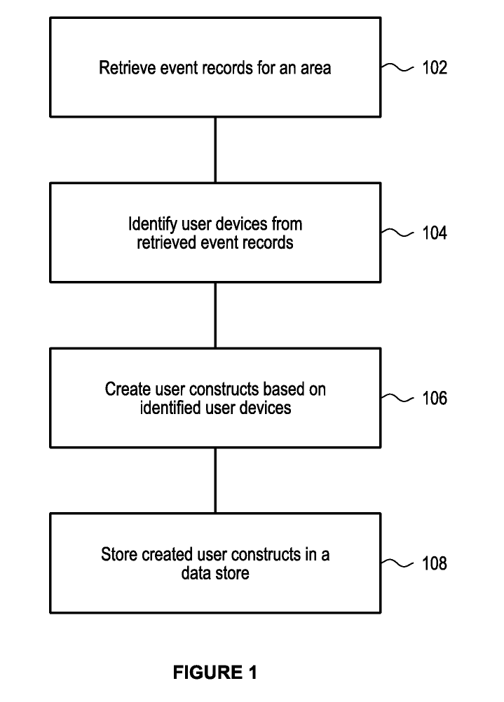

FIG. 1 shows a method for processing the event records for use in footfall analytics;

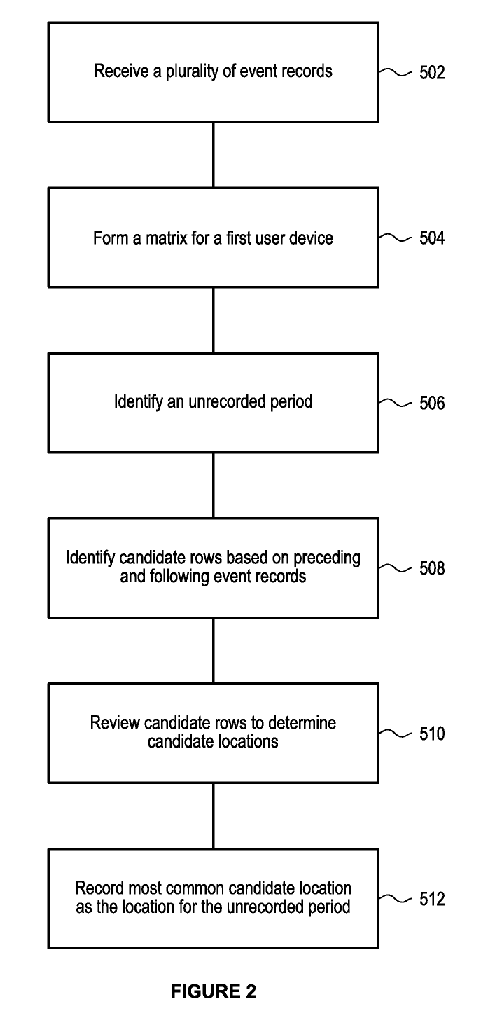

FIG. 2 shows a method for inferring a location of a user device;

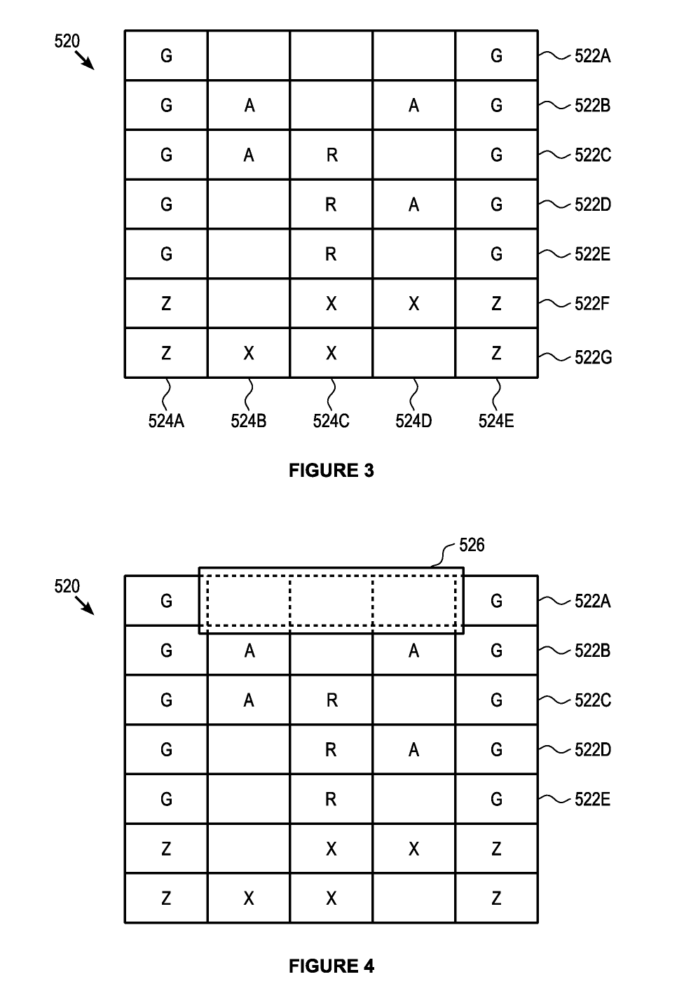

FIG. 3 shows a first exemplary method for mapping locations to time slots in a matrix;

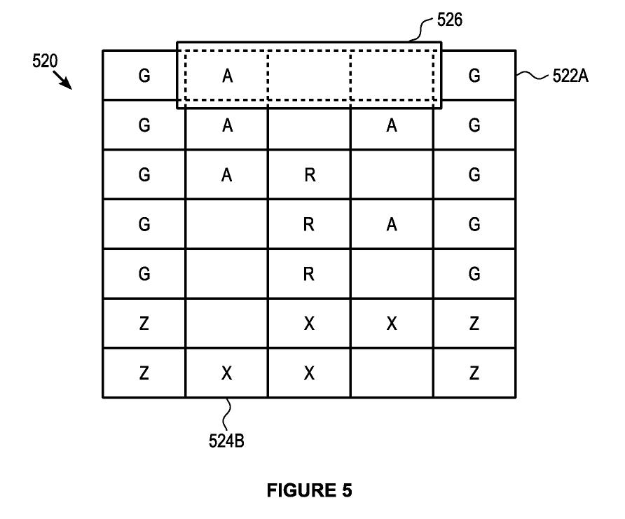

FIG. 4 shows a second exemplary method for mapping locations to time slots in a matrix;

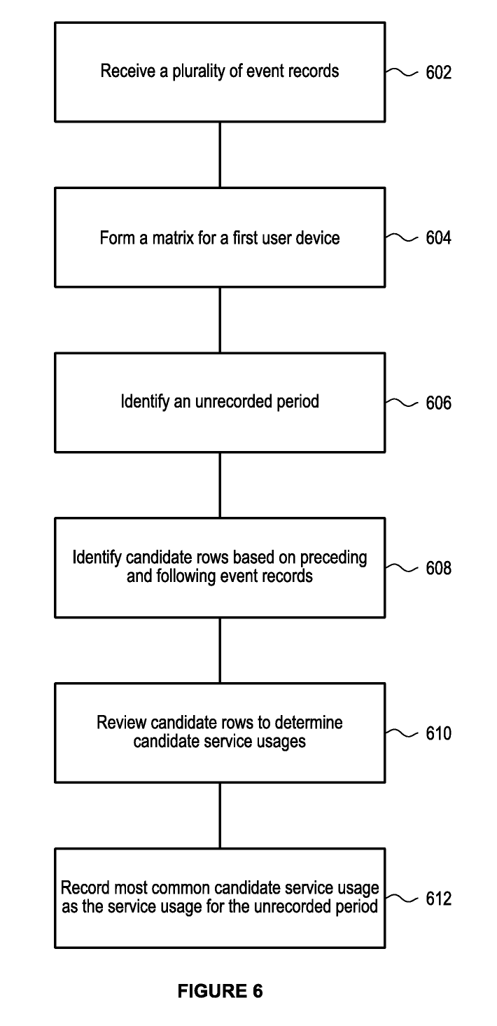

FIG. 5 shows a third exemplary method for mapping locations to time slots in a matrix;

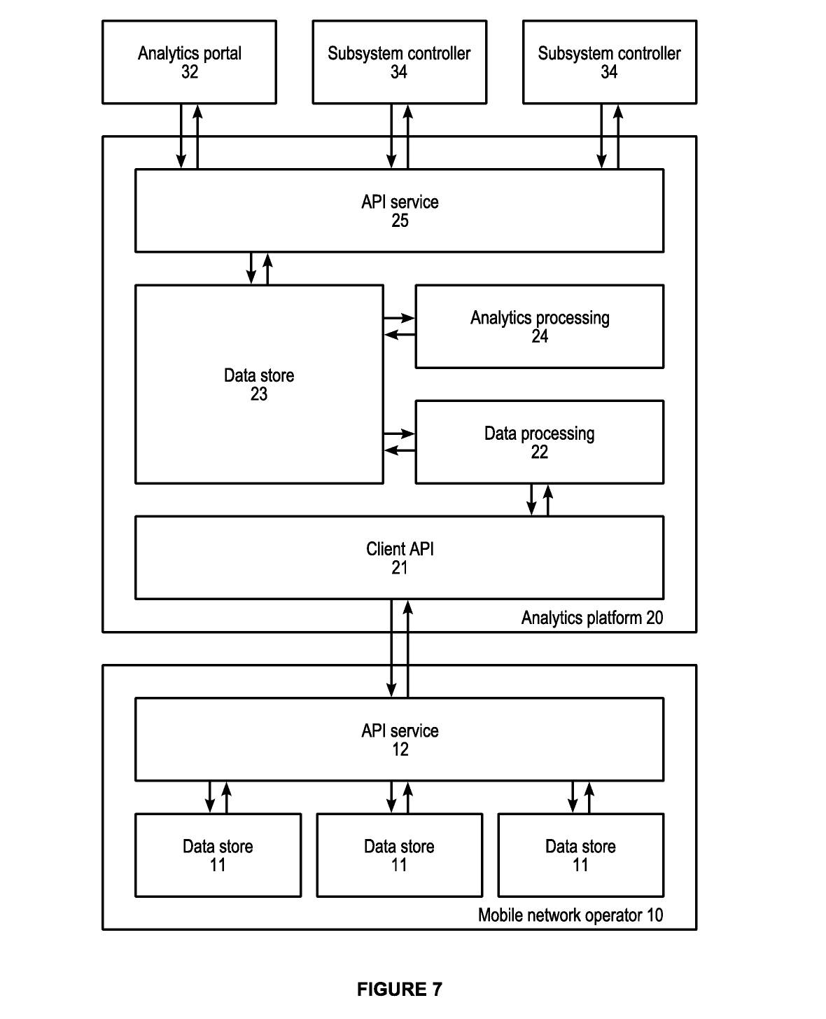

FIG. 6 shows a method for inferring the usage of a service;

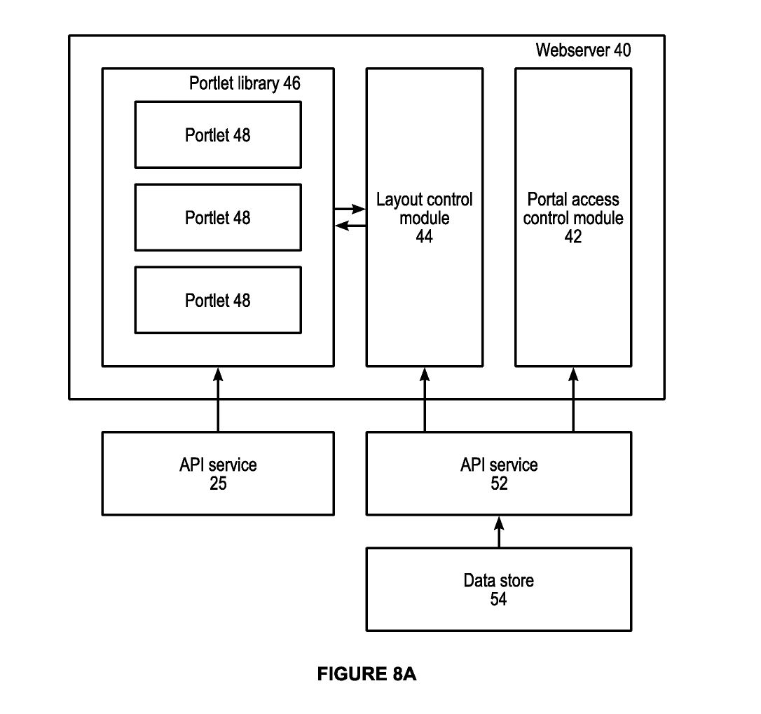

FIG. 7 shows an exemplary system for implementing the described methods; and

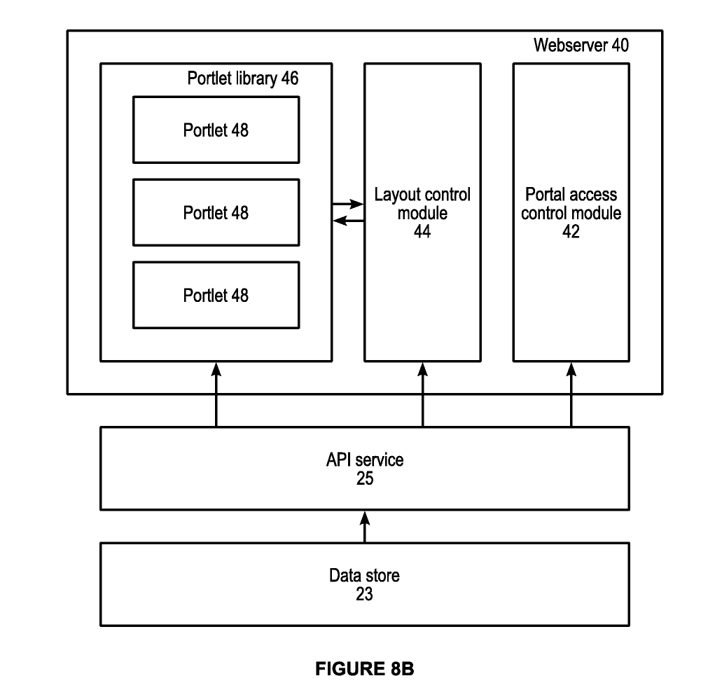

FIGS. 8A and 8B show exemplary embodiments for an analytics portal.

### DETAILED DESCRIPTION

In order to achieve any useful footfall analytics, the relevant data must first be gathered. In practice, the vast majority of people carry one or more devices with them which communicate with a base station (or telecommunications node) for mobile services and the like. Typically, a device communicates with the nearest base station.

Based on this, if a device is connected to a base station, it can be reasoned that the device is located within the area around the base station which is closer to the base station than to any other base station. This analysis can be modelled mathematically using a Voronoi algorithm to divide a large geographical area with a plurality of base stations into cells. Of course, other methodologies can be used to map mobile telecommunication cells and/or communication coverage areas into geographical areas. Each cell can therefore be mapped to a geographical area which will typically be centred on the base station.

The base station can be a conventional mobile telephony base station, providing services to a macrocell which covers an area several kilometres across. In some settings, smaller cells (such as femtocells) may also be used, particularly where service is required indoors. In such cases, each floor or room of a building may be a separate cell, and user devices can communicate with the base station for their floor.

In use, the user device communicates with the base station. In doing so, the base station typically generates and stores event records based on the events that have occurred. These events can, for example, include a phone call being established or a text message being sent. Each event record comprises time data indicating when the event occurred, device data indicating the user device that was involved, type data indicating the type of event that occurred, and cell data indicating the network cell in which the event occurred.

The time data can include a date and a time at which the event started, and the duration of the event. Alternatively, it can include a first date and time at which the event started, and a second date time at which the event finished.

The device data uniquely identifies the device which was involved in the event. This is typically by means of one or more IDs which map to a device, a user account or a user. Commonly, this includes one or more of an MSISDN for the device, an IMSI for a user (or a SIM card or device associated with the user), or an IMEI for the device. In some cases, anonymised IDs (particularly an anonymised MSISDN) may be used.

The type data identifies the type of event that occurred. For example, the event type data may indicate that the event was a telephone call. This may be done by means of a code which corresponds to an entry in a look-up table.

The cell data can be simply an identifier for the cell. However, using the mapping between cells and geographical areas, the cell data can also be used as a geographical identifier. Accordingly, using this mapping, location data for the event record can be easily computed which identifies a geographical area or location at which the event occurred.

In many cases, the event records are generated during the ordinary operation of the base station. In this case, there is little additional overhead to generate the event records, as the event records will be generated regardless of whether they are to be used for footfall analytics. In some cases, the event records may include charging data records (CDRs) generated for charging a user's account.

Although the event records above have been described with reference to events occurring at a base station, event records may additionally or alternatively be generated and/or retrieved from outside of the operation of a base station. In particular, event records may comprise records of events occurring in other networks. For example, the event records may relate to a non-telecommunication network (such as requests and responses passing through a WiFi network), the use of GPS, the internal state of devices (such as a device being switched on or connecting to a different cell) or the like.

### Data Gathering

Turning now to FIG. 1, a method for processing the event records for a geographical area is shown. Facility management subsystems are typically configured to provide services to different areas separately. For example, lighting may be required in a first area, but not a second area, even though both areas are managed by a single subsystem. It can therefore be useful to consider event records for each geographical area separately.

At step 102, event records are retrieved for a given geographical area. To do so, the identifier for the one or more cells corresponding to the geographical area is retrieved. This can be done using a look-up table or the like, which maps locations to cells. The stored event records are then filtered to produce a subset of event records relating to the identified cell. Thus, the subset only relates to events that occur within the given geographical area.

At step 104, a set of devices is identified, each of which has at least one corresponding event record in the subset of event records. The event records can then be split into multiple further subsets, each of which relate to a single user device.

At step 106, a user construct is generated for the subset relating to each user device. Each user construct comprises the subset of the event records which relate to a device, and which in turn relate to a nominal user. In some cases, a user construct can actually relate to multiple devices, for example if a single user carries two devices with them.

The user constructs can be created without necessarily having any knowledge of the users directly. In this manner, the user constructs may be anonymous. Moreover, because each user construct may only relate to a single area, the same actual user may be seen as a first user construct in a first area, and a separate second user construct in a second area.

At step 108, these user constructs are stored in a data store for future use. Once the user constructs are generated and stored, footfall analysis can be performed.

### Inferring a Location for a User Device

In ideal situations, there are events occurring almost constantly for a user device, meaning there are abundant event records from which to derive footfall analytics. However, in reality there may be gaps in the data.

This can occur simply because no events have occurred. For example, there have been no mobile calls made and no persistent connections maintained. These situations are not uncommon.

In other cases, there can be underlying infrastructure issues. For example, dead spots occur where the surrounding environment does not allow a mobile signal to enter (for example, in an underground public transport station). Alternatively, some technologies such as mobile payment systems (e.g. M-PESA™) do not require a constant data connection. In these cases, the events that occur (which may be provided retrospectively) may be lacking accurate cell/location data.

These gaps in the data can lead to less accurate footfall analytics than would otherwise be desired. Indeed, where there are underlying infrastructure issues, there would like be little to no data available.

FIG. 2 shows a method for addressing this.

Thus at step 502, a plurality of event records are received. The plurality of event records can be selected to include only event records corresponding to a first user device (that is, having device information identifying the first user device). However, if possible, the plurality of event records will also include event records corresponding to a second user device, where both the first user device and the second user device are associated with the same user.

At step 504, a matrix for the first user device is formed. The matrix maps the location of the user device to time slots during the time period of the event records. The length of the time slots is chosen to be regular enough that the movements of the user device are generally accurately modelled. A time period of between about 1 minute and about 15 minutes has been found to be suitable.

Each entry in the matrix is given a location value based on the event records. Typically this occurs by first retrieving the start time of the time slot. The event record in the plurality of event records having time data closest to the start time is selected. Finally, the location for that event record is calculated and recorded as the location for that time slot.

An example of such a matrix is shown in FIG. 3. Here, matrix 520 is shown which comprises a plurality of rows 522A-522E. Each of these rows corresponds to a day for the user device. The days need not be consecutive days. They may be selected to be the same type of day (for example, all weekdays), to be the same day of the week (for example, all Mondays) or to omit public holidays and the like which tend to disrupt normal schedules.

The matrix 520 also comprises a plurality of columns 524A-524E which correspond to the time slots during the day. In this case example, only five time slots are shown each day (which corresponds to time slots of 4.8 hours), however shorter time slots are usually used.

The matrix includes a number of unrecorded time slots, where the plurality of event records did not contain an event record corresponding to the time slot.

Returning to the method showing in FIG. 2, at step 506, an unrecorded time period (that is, one or more consecutive unrecorded time slots in the matrix) is identified. The event records immediately preceding and following the unrecorded time period are identified.

At step 508, other rows of the matrix (which may correspond to other days) are identified as candidate rows based on the preceding and following event records (and the corresponding preceding and following locations). In particular, one or more rows are identified which have a location identical to the preceding location in the same column preceding column, and a location identical to the following location in the same column as the following location.

An example of this is shown in FIG. 4. There, row 522A has been identified as having an unrecorded time period 526. The unrecorded time period has a preceding location “G” and a following location “G”. Thus rows 522B, 522C, 524D and 524E have been identified as candidate rows.

In some embodiments, each entry in the matrix includes additional information about first-seen and last-seen location values for the corresponding time slot. For example, even if an entry has the location value “B”, the entry may also record that, at the start of the time slot, the user device was at location “A” and at the end of the time slot, the user device was at location “C”. These start and end locations may also be noted in terms of a proportion of the whole time slot. For example, the user device was at location “A” for the first 5% of the time slot, and was at end location “B” for 10% of the time slot.

In such embodiments, the preceding location for a given time unrecorded time period may be deemed to be the end location for the preceding entry in the matrix. Similarly, the following location for a given unrecorded time period may be deemed to be the start location for the following entry in the matrix. In this manner, information about transitions between locations can be preserved during location inference.

Returning to the method showing in FIG. 2, at step 510, each of the candidate rows is reviewed to determine whether there exists a candidate location in one or more of the columns of the unrecorded time period. In doing so, the locations in the candidate rows are compiled for each column.

Then at step 512, for each column in the unrecorded time period, the most common location is calculated based on the compiled locations from the candidate rows. This is then assigned to the time slot in the unrecorded time period and recorded in the matrix.

Where there is no clear most common value, a “nearest neighbour” approach may be used. If an unrecorded time slot has the same location in both neighbouring time slots, at least one of which is not inferred, the unrecorded time slot may be inferred to the have the same location. This proceeds on the assumption that a user is unlikely to leave and return to a location within a short period.

An example of this is shown in FIG. 5. There, and with reference to column 524B, the most common location is “A”. Based on this, the unrecorded time slot in row 522A is assigned the value of “A”.

This process can then be repeated for the remaining unrecorded time slots in the matrix. In this manner, a completed matrix can be produced for a user device based on incomplete data.

In some cases, the unrecorded period may additionally or alternatively be compared to one or more known routes, such as transportation routes. This is particularly useful where there is little connectivity available at points along the routes. In use, if a preceding event is at a first point along a route, and the following event is at a second point along the route, then it could be inferred that the user is travelling along the route, even if there is no corresponding event records during the journey.

For example, it may be known that a train line passes from Station A to Station B along train line L. If the preceding event is at or around Station A and the following event is at Station B, it could be inferred that the unrecorded location is along train line L.

In some cases, a confidence factor can be derived for each inferred location to indicate the confidence in the accuracy of the inferred location. Using the example of FIG. 5, where every one of the candidate rows contains a location “A” in a particular row, then there can be reasonably high confidence that “A” is the correct location, and this inferred value could be marked as high confidence (for example, having a confidence factor of greater than 0.8). However, if only 1 of the candidate rows contained “A”, and all the others were blank, such a value would typically be marked as low confidence (for example, having a confidence factor of less than 0.4).

Thus in use, where a very high level of accuracy is required, the confidence factor may be required to be above a threshold (such as 0.8) before an unrecorded time slot is filled. For example, where footfall analytics are used for anti-fraud purposes, do determine whether a transaction is unlikely for a user, it would be undesirable to take any automated action based on low-quality inferred information. In such a case, a high confidence threshold (such as 0.8) may be set.

The most direct application of this technology is in the field of facility management. By having a much more accurate matrix of user movements, more accurate control of subsystems can be realised.

Another application is in the field of pre-caching and the like in a network. For example, where a large number of users are expected in a particular location, it may be seen as useful to pre-cache certain information in advance, thereby improving the performance of the network.

A further key application for this method is in electronic transaction security, and particularly in the detection of fraudulent transactions. For example, one method of fraud detection is to look at situations where two transactions take place in two different locations in a short period, such that it would be practically impossible for a user to travel between them. This detection could historically be circumvented by avoiding providing cell/location data for one of the transactions. However, the present invention provides a method for inferring such data, thereby strengthening prior art fraud detection methods.

### Inferring Service Usage

Although the description above has been phrased in terms of physical locations, the methods actually have a broader application. In particular, the above-described methods can be adapted to infer whether a user has used a particular service (such as visiting a website, using an application or watching a television channel) where no records are available.

This is of particular interest where a given user device has access to multiple networks, and switches between the networks while using services. For example, a user device may access a website using their personal WiFi while at home, and may switch to using a cellular connection (e.g. 3G, 4G etc.) through a mobile telecommunications operator while away from home. This can render it difficult for provisioning and the like to occur, as the records at any one source may include substantial unrecorded time periods.

A method for inferring service usage is shown in FIG. 6. FIG. 6 generally mirrors FIG. 2, and thus (except where logically impossible), the description above in relation to FIG. 2 applies equally to FIG. 6.

Thus, starting at step 602, a plurality of event records are received. The plurality of event records typically includes only event records corresponding to a first user device (that is, having device information identifying the first user device). However, if possible, the plurality of event records will also include event records corresponding to a second user device, where both the first user device and the second user device are associated with the same user. In this case, each event record includes service information, identifying the use of a service by the user device. This may in some cases include a frequency of use. The event records may omit location information,

At step 604, a matrix for the first user device is formed. The matrix maps the service usage of the user device to time slots during the time period of the event records. Typically, each entry records the identity of the service and the frequency of usage of the service during the time period. Multiple services may be identified in a single entry. As above, the matrix may include some time slots where no service usage has been recorded.

At step 606, an unrecorded time period (that is, one or more consecutive unrecorded time slots in the matrix) is identified. The event records immediately preceding and following the unrecorded time period are then identified.

At step 608, other rows of the matrix (which may correspond to other days) are identified as candidate rows based on the preceding and following event records (and the corresponding preceding and following service usage). Typically, the service usage must match both the identity of the service and the frequency of use for the service. Such an approach is especially valuable where the service comprises regular periodic access (for example, an application on a user device which automatically periodically updates its state from an external server).

At step 610, each of the candidate rows is reviewed to determine whether there exists a candidate service usage in one or more of the columns of the unrecorded time period. In doing so, the service usages in the different candidate rows are compiled for each column.

Finally, at step 612, for each column in the unrecorded time period, the most common service usage is calculated based on the compiled locations from the candidate rows. This service usage can then be assigned to the time slot in the unrecorded time period and recorded in the matrix.

As noted above, the method shown in FIG. 6 is of particular benefit where a user device switches between networks. Thus, in some embodiments, the method may only be performed when such a switch has been detected.

An alternative application of this approach is in determining when a user deviates from a pattern. Based on this pattern, it can be calculated that an event record should be generated at a given point in the future. If no such event record exists (that is, there is an unrecorded time period), the user can be recorded as deviating from the pattern.

Thus in one example, if a user purchases a good from a vendor (such as food products from a supermarket or fuel from a fuel supplier) once during a calculated time period (such as once every week), a corresponding pattern can be inferred. Based on this pattern, it can be expected that the records of the vendor should include a corresponding purchase in each future week. If in one week there is no record of a purchase (that is, there is an unrecorded time period), it could be inferred that the user has purchased the good elsewhere, and this may be recorded in a customer relations management system or the like.

Additionally or alternatively, based on the pattern, suggestions or recommendations could be made to the user at future matching times. The suggestions may include similar goods or services (such as music, television, applications, websites or the like) to those that appear in the records. For example, one pattern might suggest that a user regularly listens to one genre of music on Sunday mornings each week. Based on this pattern, new artists of that genre may be identified and suggested to the user during future Sunday mornings.

### Infrastructure

The methods above provide for various footfall analytics to be performed. In use, these methods are typically performed in a system. One such exemplary system is shown in FIG. 7.

In this system, the data ultimately originates from a mobile network operator 10. The data is stored in one or more data stores 11. Each of the data stores may be dedicated to a different kind of data, for example one may store event data, another may store customer data etc. For example, each data store 11 may relate to one or more of real-time network data, network and OSS data, application data or operational data.

The mobile network operator 10 provides an API service 12. In response to receiving an API call, the API service 12 retrieves the appropriate data from the data stores 11, and returns the data. Access to the API service 12 may be limited to only certain parties, and therefore may require authentication. Requests made to the API service 12 may be made as federated queries, such that, in response to the query, multiple data sources are searched and the results compiled. In some cases, the API service 12 may send data to a predetermined recipient other than in response to receiving an API call. For example, this may occur when newly stored data in the data stores 11 matches a predetermined condition. In this manner, the API service 12 may make use of “push” transmission.

The analytics platform 20 is provided to administer the methods noted above.

The analytics platform comprises a client API 21 which is configured to call the appropriate API service 12 at the mobile network operator 10. These calls are performed in order to retrieve the data (such as event records) needed for the analytic methods to be performed. The data can be retrieved in real-time (or at least in near-real-time, where data is available within around 15 minutes of the corresponding event occurring).

Communication between the API service 12 and the client API 21 typically involves a RESTful architecture. Thus, requests for resources may be made by the client API 21 using standard HTTP methods, and responses received using HTML, XML or JSON over FTP or HTTP.

Data received at the client API 21 is then transmitted to a data processing module 22. The received data may fall into one of three categories: structured data (which follows the mandatory core of a pre-agreed standard), semi-structured data (which follows the optional additions to the pre-agreed standard) or unstructured data (which does not follow a pre-agree standard).

In some cases, a plurality of mobile network operators 10 may provide API services 12 for their respective data. In this case, the client API 21 may retrieve data from each of the mobile network operators 10 in turn, and pass the retrieved data from each mobile network operator 10 in turn to the data processing module 22.

The data processing module 22 is configured to process the incoming data according to its type. More precisely, the data processing module 22 contains one or more operational service components which operate to process the data into a form suitable for storage and/or future use. The components may comprise one or more structured loaders which accept structured data. The components may additionally or alternatively comprise one or more semi-structured loaders which are configured to operate on semi-structured data. The semi-structured loaders may operate to determine the data fields of the semi-structured data and to create appropriate storage objects. The components (which may include the structured loaders or the semi-structured loaders) may operate to perform one or more of data validation, data anonymisation, data enrichment and transformation, data optimisation (such as indexing), data auditing and logging or the like. Once processed, the data is then stored in a data store 23.

The data store 23 typically holds four kinds of data: mobile subscriber data, reference data, system metadata and derived data. Mobile subscriber data contains all the “raw” data originating from the network events and pertaining to a mobile subscriber. This typically includes the event records, and can be regarded as the primary kind of data for analytics. Reference data comprises secondary data which can improve the operation of the analytics. This can include network site/cell configuration data, geographical data (such as GIS polygon data), external footfall verification statistics, population statistics or weather data. Reference data may be updated less frequently than mobile subscriber data, or may be treated as static and not updated. System metadata typically holds data related to the operation of various APIs, such as call definitions and schedule, in order to maintain flexibility within the system. Derived data comprises the calculated and inferred data based on the mobile subscriber data and the reference data.

An analytics processing module 24 is provided, which acts on the data stored in the data store 23. As will be appreciated, the analytics processing module 24 typically implements the footfall analytics methods described herein, then stores the results in the data store 23. More precisely, the analytics processing module 24 may comprise a processor and memory comprising instructions which, when executed by the processor, cause the processor to perform one or more of the methods described above.

The analytics platform 20 further comprises an API service 25 which is configured to receive requests from one or more external entities. The API service 25 may provide for one or more different classes of services. A first class comprises data extraction, whereby there is provided a mechanism for delivering raw data sets. In most cases, this is likely to be derived data. However, in some situations (such as where the primary data source is unavailable), other types of data may also be provided. A second class comprises data visualisation, whereby there is provided a mechanism for delivering data expressed in a visual manner (for example, as charts, graphs) or processed for use in visualisation (such as the provision of KML/KMZ files for geographic annotation and visualisation). A third class comprises insights, whereby there is a mechanism provided for delivering reports (preferably in a pre-defined format). This may function to provide a formatted output of raw data (which may in turn comprise visualisations).

An analytics portal 32 can be provided to allow for a user interface for the analytics platform. In particular, the analytics portal 32 is configured to allow for visualisation and reporting of the data. It typically comprises a webserver which is configured to retrieve data from the analytics platform by means of the API service 25 and to provide one or more dynamic webpages. Each webpage is generated when called to show views of the footfall data. This may be done using standard portlets.

One or more subsystem controllers 34 may also be in communication with the analytics platform by means of the API service 25. The corresponding subsystem (such as an air conditioning subsystem) can be configured to operate according to the retrieved data.

Although shown separately, it is envisioned that the analytics platform and the analytics portal may be operated together, and may be provided as a single system or computer program product, such that the analytics portal simply provides a user interface over the API service 25.

Thus, in a preferred embodiment, a system for performing analytics in a network is provided. The system preferably comprises an analytics platform 20. The analytics platform 20 preferably comprises a client API module 21 configured to call an API service 12 at a mobile network operator 10 and, in response to the call, receive data from the API service 12; a data store 23; a data processing module 22 configured to process the received data and store the processed data in the data store 23; an analytics processing module 24 configured to perform one or more analytics methods (such as those described above in relation to FIGS. 2 to 7); and an API service module 25 configured to configured to receive requests from one or more external entities, and in response to the requests, provide one or more data services.

Example analytics portal 32 will now be described in relation to FIGS. 8A and 8B. In these examples, the analytics portal 32 comprises a webserver 40. The webserver 40 is typically configured to receive requests and responses in common webserver formats (such as HTTP). Responses can include the provision of a dynamic portal or portal pages. The webserver 40 is preferably be configured to adhere to appropriate standards, such as JSR 168. In use, the webserver 40 (or at least components of the webserver 40) may be in communication with various other modules. Thus in the example shown in FIG. 8A, the webserver 40 is in communication with API service 25 in the analytics platform 20. In this manner, content required for operation of the webserver 40 may be supplied via appropriate calls to the API service 25. The webserver 40 is also in communication with a data store 54 via an API service 52 (and preferably via data extraction functions provided by API service 52). In such an example, data store 54 is typically configured to store portal metadata for the webserver 40. The data store 54 and the API service 52 can be separate from the analytics platform 20.

In some embodiments, the API service 52 and the data store 54 are integrated with the API service 25 and the data store 23. An example of this is shown in FIG. 8B, where the webserver 40 is in communication with data store 23 via API service 25 (and preferably via data extraction functions provided by API service 25, as described above). The data store 23 can therefore be configured to store portal metadata, and the API service 25 configured to supply the portal metadata on appropriate calls being made.

As can be seen in both FIGS. 8A and 8B, the webserver 40 comprises a portal access module 42 configured to assess the credentials of a user or a group, and based on this assessment, evaluate whether components (such as portlets) are visible to a given user or group. To this end, the portal access module 42 may be in communication with a data store 23, 54 holding portal metadata, preferably via a suitable API service 25, 52. Based on the results of one or more queries to the API service, the portal access module 42 can then evaluate visibility or access.

The webserver 40 further comprises a layout control module 44. The layout control module 44 is configured to query the API service 25, 52 to retrieve portal metadata, and based on the retrieved portal metadata, determine where and how to display pages and portlets. To this end, the layout control module 44 can be in communication with a portlet library 46 having one or more portlets 48, The portlet library 46 is configured to make available modular components which can be used to display different aspects of data, and preferably adheres to appropriate standards, such as JSR 168. The portlets 48 may include map portlets, chart portlets, image portlets, text portlets, or any other suitable type of portlet.

The portlet library 46 may also be configured to retrieve content from a suitable data store for use in the display of one or more of the portlets 48. In particular, the portlet library 46 may make a call to an API service 25, 52 to retrieve data for use as content. In use, each portlet 48 can be initialised and maintained by the layout control module 44 based on the retrieved portal metadata. In this manner, the layout control module 44 prepares the portal and portal pages for use in responses from the webserver 40.

Thus, in preferred embodiments, a system for operating an analytics portal is provided. The system comprises a portal access control module 42 configured to evaluate the credentials of a user or group, a portlet library 46 configured to store one or more portlets 48, and a layout control module 44 configured to initialise one or more portal pages based on portal metadata and the one or more portlets.

This application describes various embodiments of the present invention by way of one or more examples. However, as will be apparent to the skilled person, various modifications and changes can be made to the embodiments and examples described without departing from the spirit and scope of the present invention. Such modifications and changes are included within the scope of this application.

This application describes various technically implementable analytics systems and methods. Commercial implementation of any of the embodiments described in this application may be subject to applicable privacy laws.

1. A method for inferring a location of a user device in a network, the method comprising:
retrieving a plurality of event records, each event record corresponding to a user device event in a network, the record comprising a user device identifier, time information, and location information;
identifying, for a particular user device, a time period for which there exists no event record in the plurality of event records;
retrieving one or more other event records from the plurality of recorded event records based on the identified time period; and
inferring a location for the user device during the identified time period based on the one or more retrieved event records.

2. The method of claim 1, wherein retrieving one or more other event records based on the unrecorded time period comprises:
retrieving a preceding event record which comprises a device identifier corresponding to the user device and time information corresponding to a time period before the unrecorded time period; and/or
retrieving a following event record which comprises a device identifier corresponding to the user device and time information corresponding to a time period after the unrecorded time period.

3. The method of claim 0, wherein the preceding event record comprises location data relating to a first location and the following event record comprises location data relating to a second location, and wherein the method further comprises:
retrieving a route between the first location and the second location; and
inferring that the user device passed along the route during the unrecorded time period.

4. The method of claim 0, wherein the user device is associated with a user and wherein retrieving one or more other event records based on the unrecorded time period comprises:
retrieving one or more other event records, each other event record having a second device identifier corresponding to a second user device associated with the user.

5. The method of claim Error! Reference source not found., wherein identifying, for a particular user device, a time period for which there exists no event record in the plurality of event records comprises:
generating, for the user device, a matrix for the user device, the matrix comprising a plurality of time slots;
recording a location at at least some of the time slots based on the event records; and
determining the identified time period by retrieving one or more contiguous time slots in a row of the matrix, each of which time slots not having an assigned location.

6. The method of claim 0, wherein the plurality of time slots of the matrix are arranged as a plurality of rows, each row relating to a day, and a plurality of columns, each column relating to a time of day.

7. The method of claim 0, wherein each of the other retrieved records corresponds to an entry in a row of the matrix, and wherein inferring a location for the user device during the identified time period based on the one or more retrieved event records comprises:
for each time slot in the identified time period, calculating the most common location in the other retrieved records for the column of the time slot; and
recording the most common location as the location in the time slot.

8. The method of claim 1, wherein the time period relates to a day of the week, and wherein retrieving one or more other event records comprises retrieving one or more other event records which relate to the same day of the week.

9. The method of claim 1, further comprising:
calculating a confidence value for the inferred location; and
if the confidence value exceeds a threshold value, recording the location for the user device.

10. A method for inferring the usage of service by a user device in a network, the method comprising:
retrieving a plurality of event records, each event record corresponding to a user device event in a network, the record comprising a user device identifier, time information, and service information;
identifying, for a particular user device, a time period for which there exists no event record in the plurality of event records;
retrieving one or more other event records from the plurality of recorded event records based on the identified time period; and
inferring the usage of a service for the user device during the identified time period based on the one or more retrieved event records.

11. The method of claim 0, further comprising, prior to identifying a time period:
monitoring that the user device has moved from a first network to a second network.

12. A computer-readable medium having computer-executable instructions stored thereon which, when executed by a computer, cause the computer to perform the method of claim 1.
